(19) United States
(12) Patent Application Publication
(10) Pub. No.: US 2026/0197252 A1
(43) Pub. Date: Jul. 9, 2026

(54) CONTROL APPARATUS FOR RADIO ACCESS NETWORK

(71) Applicant: KDDI CORPORATION, Tokyo (JP)

(72) Inventors: Kei YONEKAWA, Fujimino-shi (JP); Yuu TSUKAMOTO, Fujimino-shi (JP); Kazuhiro SAITO, Fujimino-shi (JP); Shigeki MURAMATSU, Fujimino-shi (JP); Mori KUROKAWA, Fujimino-shi (JP); Akio IKAMI, Fujimino-shi (JP)

(21) Appl. No.: 19/555,708

(22) Filed: Mar. 3, 2026

Related U.S. Application Data
(63) Continuation of application No. PCT/JP2024/029828, filed on Aug. 22, 2024.

(30) Foreign Application Priority Data
Nov. 15, 2023 (JP) 2023-194466

(51) Int. Cl. H04L 41/16; H04L 43/0805

(52) U.S. Cl. CPC H04L 41/16; H04L 43/0805

(57) ABSTRACT

A control apparatus for a radio access network (RAN), includes: a generation unit configured to perform machine learning based on learning data and generate a first learning model; a transmission unit configured to transmit the first learning model to another control apparatus that controls the RAN using the first learning model; and a determination unit configured to obtain one or more measurement values of an inference speed of the first learning model from the other control apparatus, and determine, based on the one or more measurement values and a reference value of the inference speed, whether to transmit a second learning model to the other control apparatus, the second learning model being used for a same control as the first learning model and having a faster inference speed than the first learning model.

### CROSS-REFERENCE TO RELATED APPLICATIONS

This application is a continuation of International Patent Application No. PCT/JP2024/029828 filed on August 22, 2024, which claims priority to and the benefit of Japanese Patent Application No. 2023-194466 filed on November 15, 2023, the entire disclosures of which are incorporated herein by reference.

### BACKGROUND

### Field of the Technology

The present disclosure relates to a control technique for a radio access network (RAN).

### DESCRIPTION OF THE RELATED ART

FIG. 1 illustrates a control configuration for a RAN as proposed by the Open Radio Access Network (O-RAN) Alliance. As shown in FIG. 1, a first control function for long-cycle control and a second control function for short-cycle control are defined. In O-RAN, the first control function is referred to as a Non-Real-Time RAN Intelligent Controller (Non-RT RIC), and the second control function is referred to as a Near-Real-Time RAN Intelligent Controller (Near-RT RIC).

The first control function and second control function are connected via an A1 interface. The second control function controls RAN components, such as Central Units or Centralized Units (CUs) and Distributed Units (DUs) via an E2 interface. Here, “controlling CUs and DUs” includes notifying and setting various parameter values used by CUs and DUs in their processing, as well as instructing CUs and DUs to execute certain operations, and the like. Further, in the following description, the term “RAN” is used as a collective term for its components. Thus, for example, “controlling the RAN” means controlling CUs and DUs, which are components of the RAN. The first control function, second control function, and RAN are further connected via an O1 interface. The O1 interface may be used to transmit traffic data, performance data, failure data, and the like measured, detected and stored by the RAN.

NPL 1 discloses a configuration that utilizes machine learning for RAN control. Specifically, NPL 1 discloses generating a learning model through machine learning based on various learning data collected from the RAN and the like, performing inference using the learning model, and controlling the RAN according to the inference results. In one configuration among a plurality of configurations disclosed in NPL 1, the first control function generates the learning model. Then, the second control function uses the learning model generated by the first control function to control the RAN. Furthermore, in one of the multiple configurations disclosed in NPL 1, the first control function generates a learning model and distributes it to the second control function. The second control function updates the learning model received from the first control function through machine learning and controls the RAN using the learning model.

NPL 2 and NPL 3 disclose various control contents of the RAN based on inference results obtained from learning models. As an example, the control contents of the RAN include beamforming control, radio resource allocation, traffic prediction, and deployment control of CUs and DUs using a virtualization technique.

### Citation List

### Non Patent Literature

NPL 1: O-RAN Alliance, "AI/ML workflow description and requirements,” O-RAN. WG2. AIML-v01.03, July 2021

NPL 2: M. E. Morocho-Cayamcela, et al., "Machine Learning for 5G/B5G Mobile and Wireless Communications: Potential, Limitations, and Future Directions,” in IEEE Access, vol. 7, pp. 137184 - 137206, 2019

NPL 3: J. Kaur, et al., "Machine Learning Techniques for 5G and Beyond,” in IEEE Access, vol. 9, pp. 23472 - 23488, 2021

For example, in a case where the second control function controls the RAN based on a learning model received from the first control function or a modified version of that learning model, it is necessary to complete inference within a target time corresponding to the control content. However, there may be cases where the learning model received from the first control function or its modified version cannot complete inference within the target time. For instance, the second control function may perform various RAN control using multiple learning models generated for respective control contents. Therefore, due to limitations in the computing resources of the second control function, the inference speed when using individual learning models may vary. Furthermore, the inference speed may also vary depending on changes in the state of the RAN being controlled. Note that, in this disclosure, inference speed can be defined as the time from inputting data into the learning model to obtaining the inference result. However, the inference speed may also be defined as the time from inputting data into the learning model to obtaining the inference result and completing control based on that inference result.

### SUMMARY

According to an aspect of the present disclosure, a control apparatus for a radio access network (RAN), includes: a generation unit configured to perform machine learning based on learning data and generate a first learning model; a transmission unit configured to transmit the first learning model to another control apparatus that controls the RAN using the first learning model; and a determination unit configured to obtain one or more measurement values of an inference speed of the first learning model from the other control apparatus, and determine, based on the one or more measurement values and a reference value of the inference speed, whether to transmit a second learning model to the other control apparatus, the second learning model being used for a same control as the first learning model and having a faster inference speed than the first learning model, wherein, when the determination unit determines to transmit the second learning model to the other control apparatus, the transmission unit transmits the second learning model to the other control apparatus.

Other features and advantages of the present invention will become apparent from the following description with reference to the accompanying drawings. In the accompanying drawings, the same or similar components are denoted by the same reference numerals.

### BRIEF DESCRIPTION OF THE DRAWINGS

FIG. 1 is a control configuration diagram of a RAN according to a background art.

FIG. 2 is a control configuration diagram of a RAN according to some embodiments.

FIG. 3 is a configuration diagram of a first control apparatus according to some embodiments.

FIG. 4 is a configuration diagram of a second control apparatus according to some embodiments.

FIG. 5 is a sequence diagram according to some embodiments.

FIG. 6 is a diagram illustrating an example of measurement results according to some embodiments.

FIG. 7 is a configuration diagram of a second control apparatus according to some embodiments.

### DESCRIPTION OF THE EMBODIMENTS

The embodiments are described in detail below with reference to the accompanying drawings. The following embodiments do not limit the invention of the claims, and not all of the combinations of features described in the embodiments are essential to the invention. Two or more of the features described in the embodiments may be arbitrarily combined. The same reference number is used for the same or similar element, and duplicated explanations are omitted.

### First Embodiment

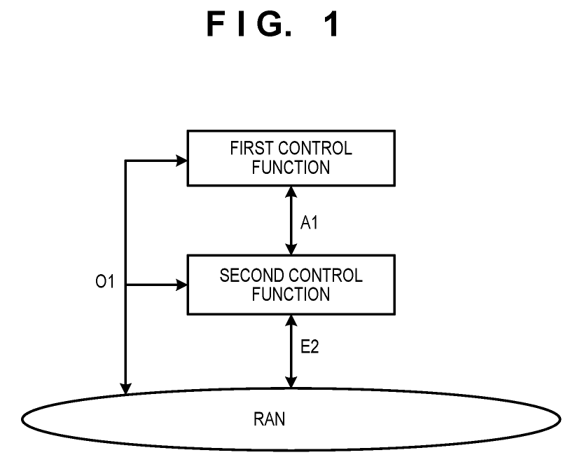

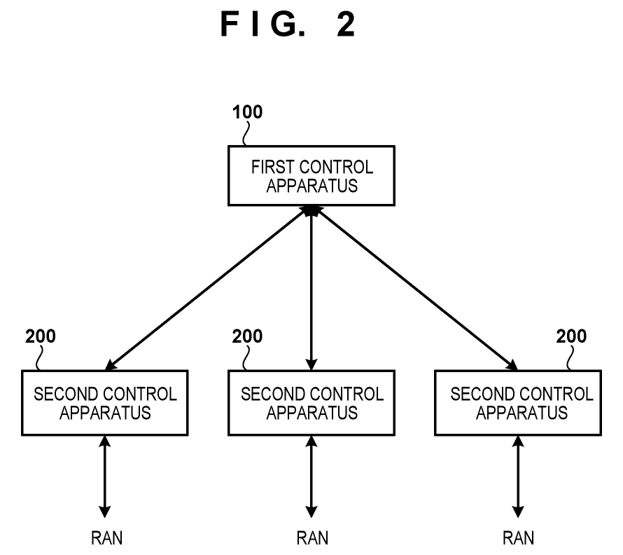

FIG. 2 shows a control configuration of a RAN according to the present embodiment. The configuration shown in FIG. 2 is basically the same as that shown in FIG. 1. The first control apparatus 100 performs long-cycle control of the RAN and is, for example, an apparatus that implements the functionality of the Non-RT RIC in O-RAN. The second control apparatus 200 controls the RAN at a shorter cycle than the first control apparatus 100 and is, for example, an apparatus that implements the functionality of the Near-RT RIC in O-RAN. The first control apparatus 100 is connected to one or more second control apparatuses 200. Note that, in the example of FIG. 2, the first control apparatus 100 is connected to three second control apparatuses 200; however, this is merely an example, and the number of second control apparatuses 200 connected to the first control apparatus 100 may be any number of one or more.

In the present embodiment, the first control apparatus 100 performs machine learning to generate a learning model and distributes the generated learning model to each second control apparatus 200. Note that the first control apparatus 100 generates learning models for one or more control contents of each second control apparatus 200 and distributes them to the respective second control apparatuses 200. Each second control apparatus 200 is associated with a geographic area and uses one or more learning models obtained from the first control apparatus 100 to control RAN components deployed in the associated geographic area. Note that the second control apparatus 200 controls a portion of the RAN of the mobile communication network that corresponds to the geographical area associated with the second control apparatus 200; however, this portion of the RAN within the mobile communication network, which is associated with the geographical area of the second control apparatus 200, is also referred to as the RAN

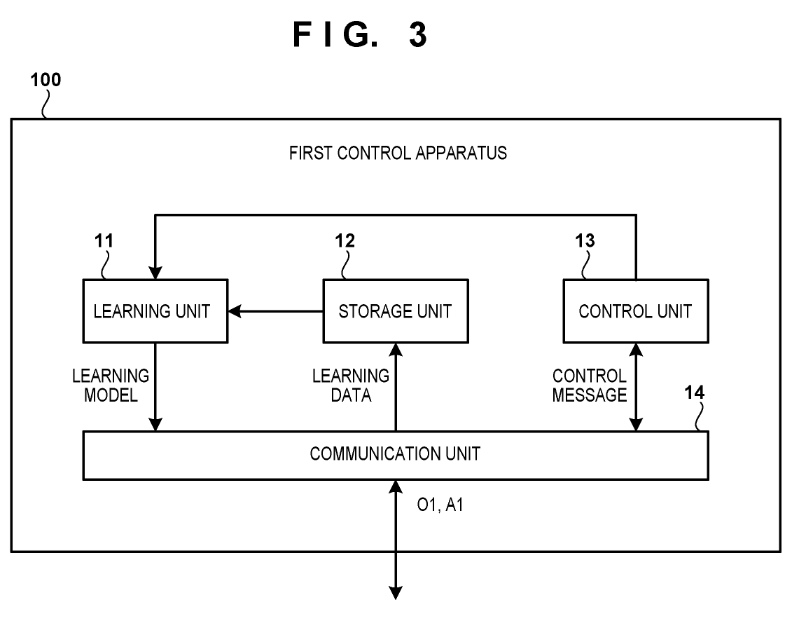

FIG. 3 is a configuration diagram of the first control apparatus 100. The communication unit 14 performs communication processing with the second control apparatus 200 via the A1 interface and communication processing with the second control apparatus 200 and the RAN via the O1 interface. The storage unit 12 stores learning data collected from the RAN via the O1 interface. Note that, in the present embodiment, learning data is collected from the RAN; however, it may also be collected from the second control apparatus 200. In a case where learning data is collected from the second control apparatus 200, either the O1 interface or the A1 interface may be used. The learning unit 11 performs machine learning based on the learning data stored in the storage unit 12 to generate a learning model. The learning unit 11 transmits the generated learning model to each second control apparatus 200 via the A1 interface of the communication unit 14. Alternatively, the O1 interface may also be used to transmit the learning model to each second control apparatus 200. The control unit 13 sends and receives control messages to and from each second control apparatus 200 via the communication unit 14. In the present embodiment, the control unit 13 uses the O1 interface to send and receive control messages to and from each second control apparatus 200; however, a configuration using the A1 interface may also be employed. Furthermore, the control unit 13 controls the learning unit 11.

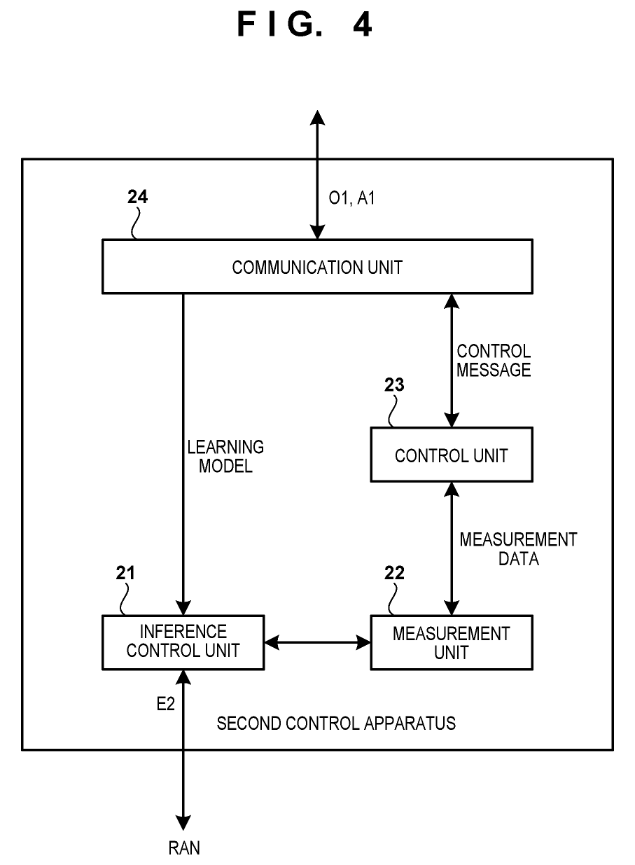

FIG. 4 is a configuration diagram of the second control apparatus 200. The inference control unit 21 performs inference based on the learning model received from the first control apparatus 100 via the communication unit 24 and controls the RAN via the E2 interface. The control unit 23 sends and receives control messages to and from the first control apparatus 100 via the communication unit 24. For example, when the control unit 23 receives a measurement request from the first control apparatus 100, it instructs the measurement unit 22 to measure the inference speed using the learning model by the inference control unit 21. When the control unit 23 receives measurement data indicating the inference speed measurement result from the measurement unit 22, it transmits the measurement result to the first control apparatus 100 by a control message.

The measurement unit 22 measures the inference speed based on a measurement instruction from the control unit 23 and outputs measurement data indicating the measurement result to the control unit 23. For example, the measurement unit 22 is configured to measure inference speed based on at least one of measurement method A and measurement method B. Measurement method A measures the inference speed when the inference control unit 21 actually controls the RAN. Measurement method B measures the inference speed by having the inference control unit 21 perform inference using test data as input to the learning model. The test data used in measurement method B may be stored in advance in the measurement unit 22. Alternatively, the test data used in measurement method B may be received from the first control apparatus 100 together with the measurement request. In the present embodiment, the first control apparatus 100 obtains learning data from the RAN; however, when the first control apparatus 100 obtains learning data from the second control apparatus 200, the second control apparatus 200 may obtain learning data from the RAN via the O1 interface or the E2 interface and transmit the learning data to the first control apparatus 100 via the A1 interface or the O1 interface.

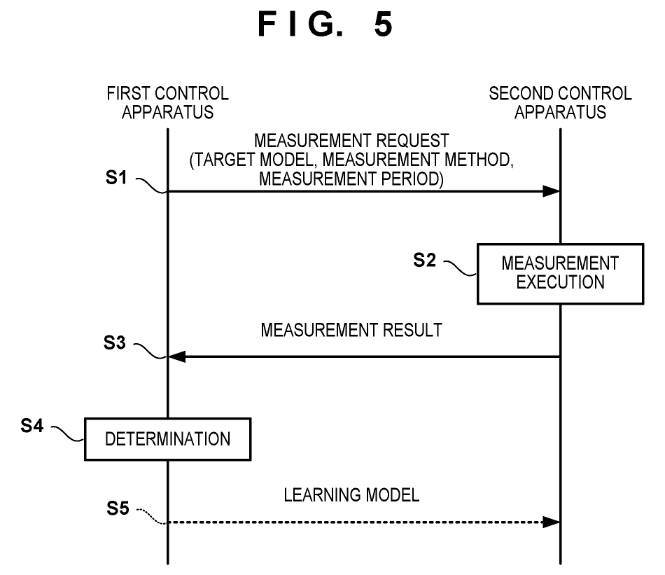

FIG. 5 is a sequence diagram of the method according to the present embodiment. In S1, the control unit 13 of the first control apparatus 100 transmits a measurement request message to the second control apparatus 200, instructing the measurement of inference speed using a learning model. When the second control apparatus 200 uses multiple learning models corresponding to multiple control contents, the measurement request message may include information indicating the “target model,” which is the learning model for which inference speed is to be measured. The number of “target models” may be one or more. Further, when the second control apparatus 200 can execute both measurement method A and measurement method B, the measurement request message may include information specifying the measurement method. When specifying measurement method B, the measurement request message may include test data. Additionally, the measurement request message may include information indicating the measurement period for inference speed.

In S2, the control unit 23 of the second control apparatus 200 instructs the measurement unit 22 to measure the inference speed of the target model in accordance with the measurement request message. In S3, the control unit 23 of the second control apparatus 200 transmits the measurement result to the first control apparatus 100.

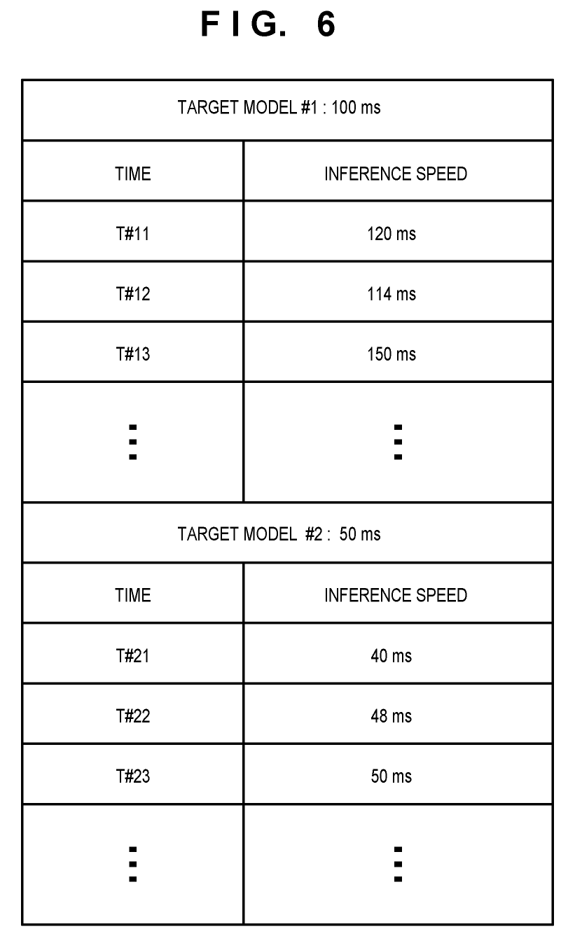

FIG. 6 illustrates an example of measurement results transmitted in S3 when, in S1, a measurement request for inference speed of two learning models, Target Model #1 and Target Model #2, is received. The measurement unit 22 repeatedly measures inference speed during the measurement period specified in the measurement request message. According to FIG. 6, for Target Model #1, inference speed is measured at times T #11, T #12, T #13, … . In FIG. 6, the measured inference speeds at times T #11, T #12, and T #13 are 120 ms, 114 ms, and 150 ms, respectively. Similarly, according to FIG. 6, for Target Model #2, inference speed is measured at times T #21, T #22, T #23, … . In FIG. 6, the measured inference speeds at times T #21, T #22, and T #23 are 40 ms, 48 ms, and 50 ms, respectively.

For example, in the case of measurement method A, the measurement unit 22 measures the inference speed during inference executed by the inference control unit 21 in each control cycle. In the case of measurement method B, the measurement unit 22 measures inference speed using test data at predetermined intervals.

Furthermore, the measurement result may include information indicating reference values for inference speed for Target Model #1 and Target Model #2. According to FIG. 6, the reference value of the inference speed by Target Model #1 is 100 ms, and that by Target Model #2 is 50 ms. The reference value for inference speed may be stored in advance in the control unit 23. Alternatively, the control unit 23 may dynamically determine the reference value for inference speed based on certain criteria. Note that if the learning model is associated with the control content and a reference value of inference speed determined according to the control content is also set in the first control apparatus 100, it is not necessary to include the reference value of inference speed in the measurement results.

In S4, the control unit 13 of the first control apparatus 100 determines, based on the measurement result received in S3, whether it is necessary to distribute another learning model with a faster inference speed for the same control content to the second control apparatus 200 for each of Target Model #1 and Target Model #2. This determination may be based on a comparison between a predetermined measurement value among one or more measurement values of inference speed obtained in S3, or the average of those values, and the reference value for inference speed of the target model.

As an example, the predetermined measurement value among one or more measurement values may be the minimum measurement value among the one or more measurement values. In this case, the control unit 13 may determine that it is necessary to distribute another learning model with a faster inference speed for the same control content to the second control apparatus 200 when the minimum measurement value among the one or more measurement values exceeds the reference value. As another example, the predetermined measurement value among one or more measurement values may be the maximum measurement value among the one or more measurement values. In this case, the control unit 13 may determine that it is necessary to distribute another learning model with a faster inference speed for the same control content to the second control apparatus 200 when the maximum measurement value among the one or more measurement values exceeds the reference value.

As yet another example, the predetermined measurement value among one or more measurement values may be a value at a predetermined rank in descending order of the one or more measurement values, or a value corresponding to a predetermined percentile among the one or more measurement values. In this case as well, the control unit 13 may determine that it is necessary to distribute another learning model with a faster inference speed for the same control content to the second control apparatus 200 when the predetermined measurement value exceeds the reference value.

Further, instead of using a predetermined measurement value among one or more measurement values, the control unit 13 may determine that it is necessary to distribute another learning model with a faster inference speed for the same control content to the second control apparatus 200 when a value obtained by performing a predetermined calculation on the one or more measurement values, such as an average, exceeds the reference value.

For example, according to FIG. 6, the reference value for inference speed of Target Model #2 is 50 ms, and the measured inference speeds are 40 ms, 48 ms, 50 ms, … , all of which are equal to or below the reference value. For example, in a case where it is determined that another learning model with a faster inference speed for the same control content needs to be distributed to the second control apparatus 200 when the minimum measurement value exceeds the reference value, the control unit 13 determines that, for Target Model #2, there is no need to distribute another learning model with a faster inference speed for the same control content to the second control apparatus 200.

On the other hand, according to FIG. 6, the reference value for inference speed of Target Model #1 is 100 ms, and the measured inference speeds are 120 ms, 114 ms, 150 ms, … , all of which exceed the reference value. For example, in a case where it is determined that another learning model with a faster inference speed for the same control content needs to be distributed to the second control apparatus 200 when the minimum measurement value exceeds the reference value, the control unit 13 determines that, for Target Model #1, it is necessary to distribute another learning model with a faster inference speed for the same control content to the second control apparatus 200. In this case, the control unit 13 instructs the learning unit 11 to transmit another learning model with a faster inference speed for the same control content to the second control apparatus 200. The learning unit 11 transmits another learning model to the second control apparatus 200 in S5 based on this instruction.

Note that the learning unit 11 may be configured to generate multiple learning models for a single control content in advance. The inference speed of each learning model for the same control content differs. Further, the learning unit 11 may be configured to generate one learning model for a single control content in advance and then generate another learning model with a faster inference speed using a compression technique, such as Symmetric Static Quantization. By compressing a learning model using a compression technique, the inference speed of the learning model becomes faster than that of the original learning model, but inference performance generally degrades. Therefore, in S5, the control unit 13 may select the learning model with the highest inference performance within a range where the average, minimum, or maximum inference speed does not exceed the reference value, and transmit it to the second control apparatus 200.

With the above configuration, it is possible to suppress a decrease in inference speed of learning models used for controlling the RAN.

### Second Embodiment

Next, the second embodiment will be described, focusing on differences from the first embodiment. The control configuration of the RAN in the present embodiment is as shown in FIG. 2, and the configuration of the first control apparatus 100 is as shown in FIG. 3.

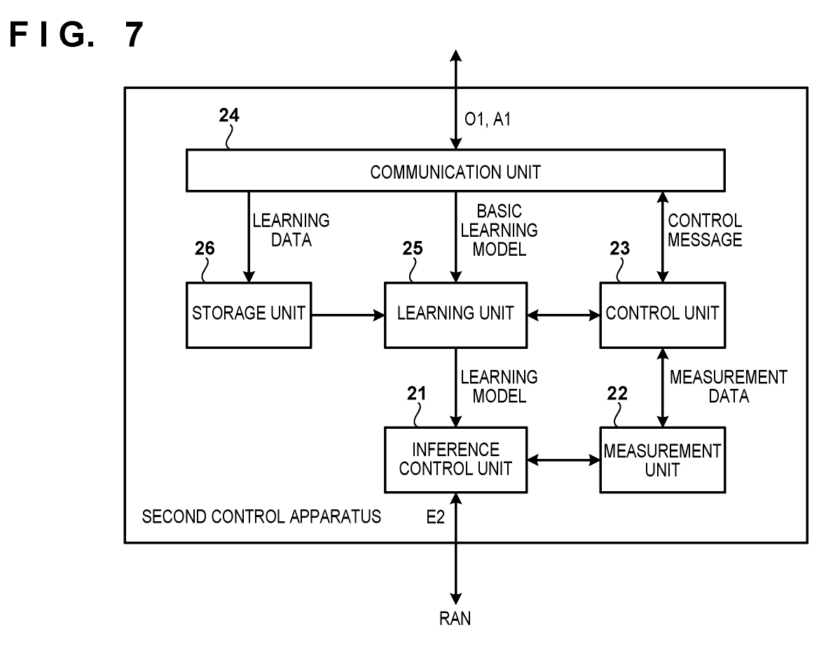

FIG. 7 is a configuration diagram of the second control apparatus 200 according to the present embodiment. The second control apparatus 200 of the present embodiment includes a storage unit 26 for storing learning data and a learning unit 25. The storage unit 26 stores learning data collected from the RAN via the O1 interface or the E2 interface. The learning unit 25 updates the basic learning model received from the first control apparatus 100 via the communication unit 24 through machine learning based on the learning data, and generates a learning model. The inference control unit 21 performs inference based on the learning model trained by the learning unit 25 and controls the RAN via the E2 interface.

In the present embodiment, the control unit 23 causes the measurement unit 22 to measure inference speed at a predetermined timing even without a measurement request from the first control apparatus 100. Then, based on the measured value and the reference value of the inference speed, the control unit 23 causes the learning unit 25 to perform compression processing on the learning model so that the inference speed satisfies a predetermined condition. The predetermined condition may be the same as the condition used in S4 of FIG. 5 in the first embodiment to determine that there is no need to distribute another learning model with a faster inference speed for the same control content to the second control apparatus 200. In other words, for example, the predetermined condition may be that a specific measured value or an average value among one or more measured values of measured inference speeds does not exceed the reference value. The control unit 23 also executes the process shown in FIG. 5 triggered by receiving a measurement request from the first control apparatus 100.

Unlike the first embodiment, in the present embodiment, the learning unit 25 can update the learning model by using compression processing so that the inference speed satisfies the predetermined condition. However, depending on the basic learning model initially received from the first control apparatus 100, there may be cases where the processing in the learning unit 25 cannot update the learning model to satisfy the predetermined condition for inference speed. In such cases, according to the sequence in FIG. 5, the first control apparatus 100 can determine that the inference speed in the second control apparatus 200 does not satisfy the predetermined condition. If the first control apparatus 100 determines that the inference speed in the second control apparatus 200 does not satisfy the predetermined condition, then in S5, it sends another basic learning model with a faster inference speed for the same control content to the second control apparatus 200.

With the above configuration, it is possible to suppress a decrease in inference speed of learning models used for controlling the RAN. In the present embodiment as well, similar to the first embodiment, the first control apparatus 100 determines, based on one or more measurement values of inference speed received from the second control apparatus 200, whether it is necessary to transmit another basic learning model with a faster inference speed to the second control apparatus 200. However, if the second control apparatus 200 determines that it cannot update the basic learning model received from the first control apparatus 100 to satisfy the predetermined conditions, the configuration may also allow the second control apparatus 200 to request another basic learning model with a faster inference speed from the first control apparatus 100.

Note that the first control apparatus 100 and the second control apparatus 200 may be implemented as a single apparatus, such as a single computer. Furthermore, the first control apparatus 100 and the second control apparatus 200 may be implemented as multiple apparatuses capable of communicating with each other, such as multiple computers.

Further, according to the present disclosure, a program executable by one or more processors is provided. The program includes instructions which, when executed by one or more processors of an apparatus, causes the apparatus to function as the first control apparatus 100 or the second control apparatus 200. Further, according to the present disclosure, a non-transitory computer readable storage medium storing the above program is provided. Moreover, according to the present disclosure, a method executed by the first control apparatus 100 or a method executed by the second control apparatus 200, such as the method shown in FIG. 5, is provided to suppress a decrease in inference speed of learning models used for controlling the RAN. Furthermore, according to the present disclosure, there is provided a program for causing an apparatus having one or more processors to execute a method performed by the first control apparatus 100 or a method performed by the second control apparatus 200, and a non-transitory computer readable storage medium storing the program.

The present invention is not limited to the above embodiments, and various changes and modifications can be made within the spirit and scope of the present invention.

What is claimed is:

1. A control apparatus for a radio access network (RAN), comprising:
a generation unit configured to perform machine learning based on learning data and generate a first learning model;
a transmission unit configured to transmit the first learning model to another control apparatus that controls the RAN using the first learning model; and
a determination unit configured to obtain one or more measurement values of an inference speed of the first learning model from the other control apparatus, and determine, based on the one or more measurement values and a reference value of the inference speed, whether to transmit a second learning model to the other control apparatus, the second learning model being used for a same control as the first learning model and having a faster inference speed than the first learning model,
wherein, when the determination unit determines to transmit the second learning model to the other control apparatus, the transmission unit transmits the second learning model to the other control apparatus.

2. The control apparatus according to claim 1, wherein the second learning model is generated from the first learning model.

3. The control apparatus according to claim 2, wherein the second learning model is generated by compression processing of the first learning model.

4. The control apparatus according to claim 1, wherein the determination unit determines to transmit the second learning model to the other control apparatus when a predetermined measurement value among the one or more measurement values exceeds the reference value, or when a value based on the one or more measurement values exceeds the reference value.

5. The control apparatus according to claim 1, wherein the determination unit requests the other control apparatus to perform measurement and obtains the one or more measurement values of the inference speed of the first learning model from the other control apparatus in response to the request.

6. The control apparatus according to claim 1, wherein the determination unit obtains the reference value from the other control apparatus.

7. The control apparatus according to claim 1, wherein the other control apparatus is an apparatus implementing a Near-RT RIC.

8. The control apparatus according to claim 1, wherein the control apparatus is an apparatus implementing Non-RT RIC.

9. A control apparatus for a radio access network (RAN), comprising:
a first control unit configured to perform inference based on a first learning model received from another control apparatus and control the RAN based on an inference result;
a measurement unit configured to measure an inference speed of the first learning model; and
a second control unit configured to control transmission of one or more measurement values of the inference speed of the first learning model measured by the measurement unit to the other control apparatus.

10. The control apparatus according to claim 9, wherein the second control unit transmits the one or more measurement values to the other control apparatus in response to a measurement request from the other control apparatus.

11. The control apparatus according to claim 9, wherein the second control unit transmits a reference value of the inference speed of the first learning model together with the one or more measurement values to the other control apparatus.

12. The control apparatus according to claim 9, wherein the other control apparatus is an apparatus implementing a Non-RT RIC.

13. The control apparatus according to claim 9, wherein the control apparatus is an apparatus implementing a Near-RT RIC.
